(19) United States
(12) Patent Application Publication
(10) Pub. No.: US 2016/0236727 A1
(43) Pub. Date: Aug. 18, 2016

(54) Aerodynamic Drag Reducing Device for Pickup Trucks

(71) Applicant: Brett Stuart Herndon, Little Rock, AR (US)

(72) Inventor: Brett Stuart Herndon, Little Rock, AR (US)

(21) Appl. No.: 14/623,739

(22) Filed: Feb. 17, 2015

(51) Int. Cl. B62D 35/00

(52) U.S. Cl. CPC B62D 35/007

(57) ABSTRACT

An aerodynamic drag reducing device for a pickup which has a main top panel and two opposed side panels which is mounted to the cab of the pickup truck upon the aft facing, rearward surface of the truck cab that contains the rear window. The aerodynamic drag reducing device is mounted to the back of the truck cab along the upper edge and the two opposed side edges of the truck cab rear window perimeter. Installation of the aerodynamic drag reducing device effectively increases the fuel efficiency of the pickup truck by reducing the low air pressure region created behind the truck cab while the pickup truck is in motion through the atmosphere.

### CROSS-REFERENCE TO RELATED APPLICATIONS

This application claims the benefit of provisional patent application Ser. No. 61/942,784, filed 2014 Feb. 21 by the present inventor.

### BACKGROUND OF THE INVENTION

1. Field of the Invention

This invention relates generally to aerodynamic drag reducing devices for pickup trucks. More particularly, this invention relates to an aerodynamic drag reducing device which is affixed to the rearward surface of the pickup truck cab. The aerodynamic drag reducing device is three faceted with a left and right side panel connected to a main upper panel. The three faceted aerodynamic device is mounted to the truck cab generally along the upper edge perimeter and the opposed left and right side edge perimeters of the rear window of the truck cab. Known prior art most relevant to this invention can be found in U.S. Patent Class 296 subclass 180.1 and 37.6.

2. Description of Prior Art

For several years cover systems of various forms have been developed to cover the open beds of pickup trucks. In more recent years, low profile covers systems (tonneau covers) to cover the open bed of a pickup truck have been developed. Utilization of a tonneau cover type bed cover assembly has been shown to improve the fuel efficiency of the truck upon which it is mounted.

However, for purposes of further reducing the aerodynamic drag of a pickup truck to improve fuel efficiency, a new aerodynamic drag reducing device has been developed to be utilized in conjunction with a tonneau cover. The new device is to be affixed upon the rear facing surface of the pickup truck cab along the upper and opposed side edges of the rear window of the cab. This new drag reducing device also affords shade from the sun for the rear window of the cab and offers protection from snow and ice buildup upon the rear window in inclement weather.

Both U.S. Pat. No. Des. 286,143 to James Lund (1986) and U.S. Pat. No. 6,126,229 to David M. Lund (2000), show pickup truck cab fairings affixed to the cab and cargo bed of a pickup truck. In U.S. Pat. No. Des. 286,143, Lund states, “The ornamental design for an air spoiler for pickup trucks, as shown and described.” The description generally shows an air spoiler with two opposed sides and a top middle section mounted upon the top surface of the forward side walls of the truck bed adjacent to the aft facing surface of the truck cab. The air spoiler is not attached to the rear facing surface of the cab but instead sets upon and is attached to the top surface of the opposed sides of the truck bed at the forward end of the truck bed nearest the truck cab.

The new aerodynamic drag reducing device for pickup trucks is to meant to be affixed to the rearward facing surface of the pickup truck cab that contains the rear window. This new device does not set upon or is connected to the truck bed. U.S. Pat. No. DES. 286,143 makes no claim as to any effect the ornamental design for an air spoiler may have on reducing the aerodynamic drag of the pickup truck it is affixed to.

A pickup truck with the new aerodynamic device mounted to the aft surface of the truck cab benefits from a reduction in aerodynamic drag thereby increasing the fuel efficiency of the pickup truck. The new aerodynamic device is most effective in reducing aerodynamic drag when utilized in conjunction with a flat tonneau cover mounted over the open bed of a pickup truck. In another embodiment of the invention, the new aerodynamic device can be used on a pickup truck with an open truck bed but the reduction in aerodynamic drag is diminished when used without a tonneau cover covering the bed due to the aerodynamic drag of the open bed.

In U.S. Pat. No. 6,126,229 Lund states, “A cab fairing for attachment to a pickup truck cab is provided. The cab fairing includes a left side panel, a right side panel, and a wing panel. The left and right side panels include a forward region having a forward edge for adhesive attachment to a pickup truck sidewalls provided beyond the pickup truck driver and passenger doors. The left and right side panels can additionally be adhesively attached to the pickup truck roof. The wing panel includes a forward region having a forward edge for adhesive attachment to the roof of the pickup truck cab.”

In every embodiment of the new aerodynamic drag reducing device, the device is affixed to the rearward facing surface of the truck cab only. Additionally, the new aerodynamic device is mechanically fastened to the rearward facing surface of the truck cab. The new aerodynamic device is affixed to the truck cab along the outer left and right side and upper perimeter of the rear window of the truck cab not along the forward sides and roof of the truck cab itself.

### BRIEF SUMMARY OF THE INVENTION

The invention, an improved aerodynamic drag reducing device for pickup trucks, which is affixed to the rear exterior surface of the pickup truck cab generally mounted upon the cab rear along the top and two side outer perimeter edges of the rear window of the cab. The new aerodynamic drag reducing device reduces the aerodynamic drag of the pickup truck upon which it is mounted by reducing the low pressure region which forms behind the truck cab while the truck is in motion through the air thereby improving the fuel efficiency of the pickup truck. The new aerodynamic drag reducing device also shades the rear window of the cab from sunlight and protects the rear window from the buildup of frozen precipitation such as snow and ice.

Accordingly several objects and advantages of the invention are to provide an improved aerodynamic drag reducing device to increase the fuel efficiency of a pickup truck and to provide protection for the rear window from the heat of sunlight and frozen precipitation. Still further objects and advantages will become apparent from a study of the following description and accompanying drawings.

### BRIEF DESCRIPTION OF THE SEVERAL VIEWS OF THE DRAWINGS

In the following drawings, which form part of the specification and which are to be construed in conjunction therewith, and in which like reference numbers have been employed throughout where possible to indicate like parts in various views:

FIG. 1 is a fragmentary perspective view with the aerodynamic drag reducing device mounted to the rear facing surface of a conventional truck cab. The truck bed is shown open, without coverage.

FIG. 2 is a fragmentary right side view with the aerodynamic drag reducing device shown mounted to the rear facing surface of a conventional pickup truck cab. No cover is present over the truck bed.

FIG. 3 is a fragmentary perspective view, similar to FIG. 1, with the aerodynamic drag reducing device mounted to the rear facing surface of a conventional pickup truck cab. A tonneau cover is shown covering the truck bed.

FIG. 4 is a fragmentary right side view, similar to FIG. 2, with the aerodynamic drag reducing device mounted to the rear facing surface of a conventional pickup truck cab. A tonneau cover is shown mounted over the truck bed.

### DETAILED DESCRIPTION OF THE INVENTION

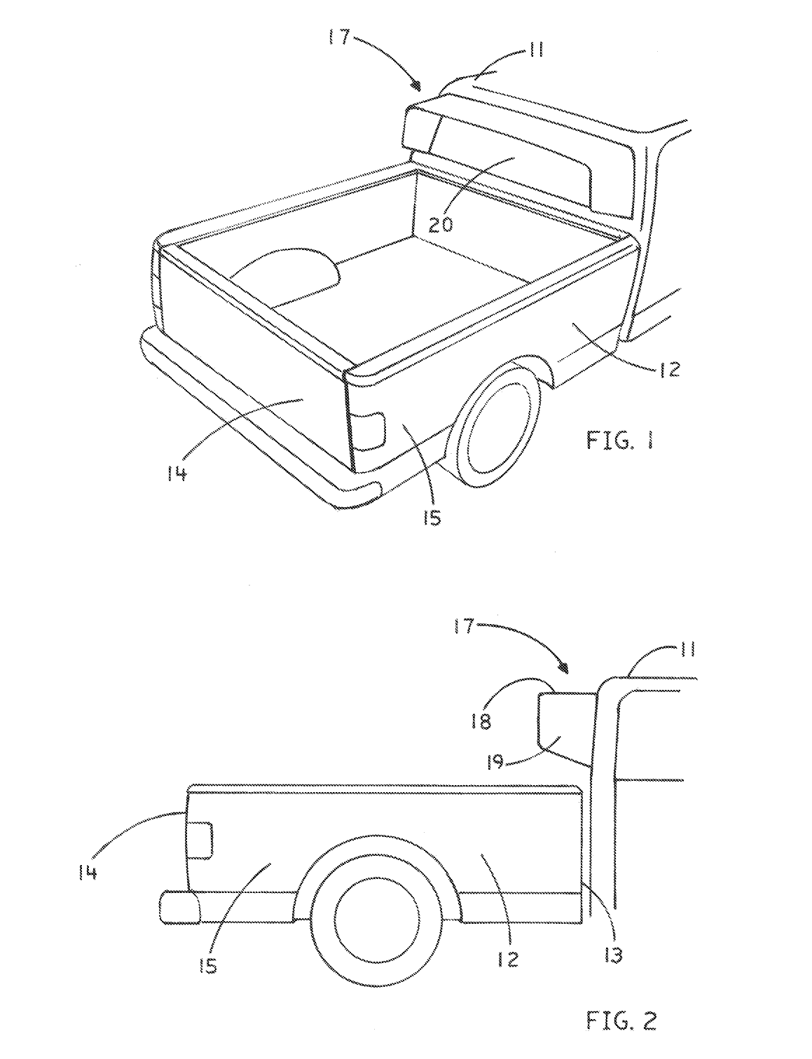

With initial reference directed to FIGS. 1 and 2 of the appended drawings, a conventional pickup truck having a cab 11, a conventional truck bed 12, situated behind the cab 11. Truck bed 12 has a front panel 13, two opposed side panels 15 and a tailgate 14. The instant aerodynamic drag reducing device 17 is shown affixed to the rear facing surface of truck cab 11 framing the truck cab window 20 along the top edge and opposed side edges of truck cab window 20. The truck bed 12 is illustrated with no coverage upon it and the tailgate 14 is shown in a raised, closed position. The aerodynamic drag reducing device 17 is comprised of a top panel 18 connected to two opposed side panels 19 and open at the bottom.

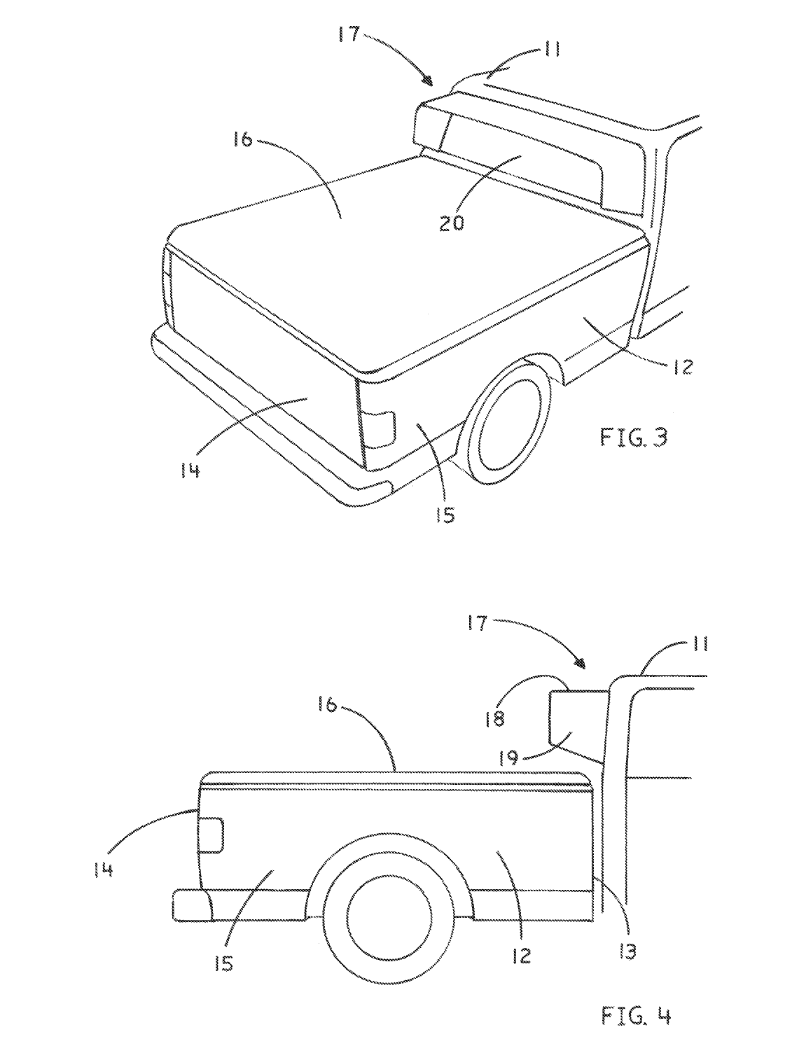

Another embodiment of aerodynamic drag reducing device 17 is illustrated in FIGS. 3 and 4. The aerodynamic drag reducing device 17 is shown affixed to the rearward facing surface of the truck cab 11 mounted to cab 11 along the top edge and opposed side edges of truck cab rear window 20. The drag reducing device 17 is shown being utilized in conjunction with tonneau cover 16 which is disposed on top of and covering truck bed 12 in both FIGS. 3 and 4.

### Operation

The aerodynamic drag reducing device 17 is statically affixed to the rearward facing surface of the truck cab 11 framing truck cab rear window 20 along the upper and opposed side edges of truck cab window 20, (FIGS. 1, 2, 3 and 4). Device 17 affords shade to the rear window 20 and reduces the buildup of snow and ice upon rear window 20 in inclement weather. Device 17 mainly increases the fuel efficiency of a conventional pickup truck by effectively reducing the low pressure region formed behind the truck cab 11 when the pickup truck is in motion through the atmosphere.

The aerodynamic drag reducing device 17 can be utilized on a pickup truck with the truck bed 12 having no coverage or in conjunction with a flat tonneau cover 16 or the like to achieve optimum reduction in aerodynamic drag further increasing the fuel efficiency of a pickup truck.

What is claimed is:

1. An aerodynamic drag reducing device for conventional pickup trucks of the type having a cab, a rear cargo bed bounded by a front wall, opposed side walls and a rear tailgate,
said truck cab having a rear window, said rear window being trapezoidal in shape being bounded within a perimeter having an upper edge, opposed side edges and a lower edge,
said drag reducing device mechanically affixed to said truck cab rear window positioned along said upper edge and opposed side edges of said rear window,
said drag reducing device being three faceted comprised of a main panel and two opposed side panels.

2. An aerodynamic drag reducing device for conventional pickup trucks of the type having a cab, a rear cargo bed bounded by a front wall, opposed side walls and a rear tailgate,
said drag reducing device affixed to said truck cab rear window effectively framing said truck cab rear window along said upper edge and opposed side edges of said rear window thereby reducing the aerodynamic drag of said conventional pickup truck by reducing the low pressure region formed behind said truck cab while said pickup truck is in motion,
said drag reducing device to be utilized with said pickup truck bed either covered or said pickup truck bed uncovered.
